(19) United States
(12) Patent Application Publication
(10) Pub. No.: US 2026/0153590 A1
(43) Pub. Date: Jun. 4, 2026

(54) MOUNTAIN RESCUE SYSTEM AND MOUNTAIN RESCUE METHOD

(71) Applicant: Metal Industries Research & Development Centre, Kaohsiung (TW)

(72) Inventors: Kuang-Shine Yang, Tainan City (TW); Chao Chieh Hsu, Kaohsiung City (TW); Ping-Hua Su, Kaohsiung City (TW); Tsung-Yi Lan, Kaohsiung City (TW); Jui-Wen Yang, Kaohsiung City (TW); Hung-Chun Shen, Kaohsiung City (TW)

(73) Assignee: Metal Industries Research & Development Centre, Kaohsiung (TW)

(21) Appl. No.: 18/967,516

(22) Filed: Dec. 3, 2024

(51) Int. Cl. G01S 5/02; G01S 5/04; G05D 1/656; G05D 1/69; G05D 105/55; G05D 109/20; H04W 4/90

(52) U.S. Cl. CPC G01S 5/0249; G01S 5/02213; G01S 5/04; G05D 1/656; G05D 1/69; H04W 4/90; G01S 2205/06; G05D 2105/55; G05D 2109/20

(57) ABSTRACT

A mountain rescue system and a mountain rescue method are provided. The mountain rescue method includes: transmitting, by a mobile device, a radio frequency signal; flying, by a first drone, along a first path to search for the radio frequency signal; flying, by a second drone, along a second path to search for the radio frequency signal; in response to the first drone detecting the radio frequency signal, updating, by the second drone, the second path according to a first position of the first drone to detect the radio frequency signal; and in response to the first drone and the second drone detecting the radio frequency signal, positioning the mobile device according to the first position and a second position of the second drone to generate a first positioning result.

### BACKGROUND

### Technical Field

The disclosure relates to a drone technology, and in particular, to a mountain rescue system and a mountain rescue method.

### Description of Related Art

Mountain rescue is expensive and difficult to implement. Due to the weather and terrain, it is difficult for rescue personnel to move or search in the mountains. Delays in the search may result in loss of life. Moreover, during the mountain rescue process, the safety of rescue personnel is often threatened. Accordingly, how to quickly perform mountain rescue in an automated manner is one of the important topics in the field.

### SUMMARY

The disclosure provides a mountain rescue system through which a target holding a mobile device can be quickly and accurately positioned.

The disclosure provides a mountain rescue system including a mobile device, a first drone, a second drone, and a ground control station. The mobile device transmits a radio frequency signal. The first drone flies along a first path to search for the radio frequency signal. The second drone flies along a second path to search for the radio frequency signal. The ground control station is communicatively connected to the first drone and the second drone. In response to the first drone detecting the radio frequency signal, the second drone updates the second path according to a first position of the first drone to detect the radio frequency signal. In response to the first drone and the second drone detecting the radio frequency signal, the ground control station positions the mobile device according to the first position and a second position of the second drone to generate a first positioning result.

In an embodiment of the disclosure, the mountain rescue system further includes a third drone. The third drone is communicatively connected to the ground control station and flies along a third path to search for the radio frequency signal. In response to the first drone detecting the radio frequency signal, the third drone updates the third path according to the first position to detect the radio frequency signal. In response to the first drone, the second drone, and the third drone detecting the radio frequency signal, the ground control station positions the mobile device according to the first position, the second position, and a third position of the third drone.

In an embodiment of the disclosure, the ground control station performs triangulation based on the first position, the second position, and the third position to position the mobile device.

In an embodiment of the disclosure, in response to the first drone detecting the radio frequency signal, the first drone performs hovering or circling.

In an embodiment of the disclosure, in response to the first drone detecting the radio frequency signal, the second drone performs circling according to the updated second path.

In an embodiment of the disclosure, each path point on the updated second path is separated from the first position by a predetermined distance.

In an embodiment of the disclosure, a first flight altitude of the first drone is different from a second flight altitude of the second drone.

In an embodiment of the disclosure, the first drone captures an image based on the first positioning result. The ground control station positions the mobile device according to the image to generate a second positioning result.

In an embodiment of the disclosure, a first coverage area of the first drone flying along the first path and a second coverage area of the second drone flying along the second path do not overlap.

The disclosure further provides a mountain rescue method, and the method includes the following steps. A mobile device transmits a radio frequency signal. A first drone flies along a first path to search for the radio frequency signal. A second drone flies along a second path to search for the radio frequency signal. In response to the first drone detecting the radio frequency signal, the second drone updates the second path according to a first position of the first drone to detect the radio frequency signal. In response to the first drone and the second drone detecting the radio frequency signal, the mobile device is positioned according to the first position and a second position of the second drone to generate a first positioning result.

To sum up, in the mountain rescue system provided by the disclosure, the drones are able to accurately position the mobile device or the holder of the mobile device based on the radio frequency signal and the image emitted by the mobile device.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic view illustrating a mountain rescue system according to an embodiment of the disclosure.

FIG. 2 is a top view illustrating a drone fleet searching for a radio frequency signal.

FIG. 3 is a top view illustrating path updated by drones according to an embodiment of the disclosure.

FIG. 4 is a top view illustrating positioning a mobile device according to an embodiment of the disclosure.

FIG. 5 is a flow chart illustrating a mountain rescue method according to an embodiment of the disclosure.

### DESCRIPTION OF THE EMBODIMENTS

In order to make the disclosure more comprehensible, several embodiments are described below as examples of implementation of the disclosure. Moreover, elements/components/steps with the same reference numerals are used to represent the same or similar parts in the drawings and embodiments.

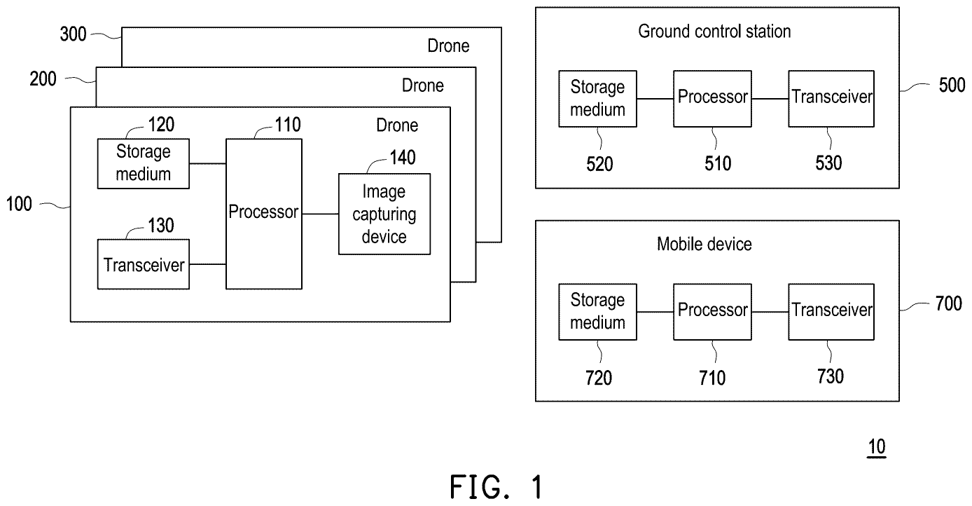

FIG. 1 is a schematic view illustrating a mountain rescue system 10 according to an embodiment of the disclosure. The mountain rescue system 10 may include a drone fleet including a plurality of drones (e.g., a drone 100, a drone 200, or a drone 300), a ground control station (GCS) 500, and a mobile device 700. The ground control station 500 may be communicatively connected to each drone. Although only three drones are shown in FIG. 1, the disclosure is not limited thereto. For instance, the mountain rescue system 10 may include N drones, where N is a positive integer greater than or equal to 2.

The drone 100 may include a processor 110, a storage medium 120, a transceiver 130, and an image capturing device 140. The drone 200 or the drone 300 may have the same structure and function as the drone 100.

The processor 110 may be, for example, a central processing unit (CPU), a programmable micro control unit (MCU) for general or special use, a microprocessor, a digital signal processor (DSP), a programmable controller, an application specific integrated circuit (ASIC), a graphics processing unit (GPU), an image signal processor (ISP), an image processing unit (IPU), an arithmetic logic unit (ALU), a complex programmable logic device (CPLD), a field programmable gate array (FPGA), other similar devices, or a combination of the foregoing devices. The processor 110 may be coupled to the storage medium 120, the transceiver 130, and the image capturing device 140 and access and execute a plurality of modules and various application programs stored in the storage medium 120.

The storage medium 120 is, for example, a fixed or movable random access memory (RAM) in any form, a read-only memory (ROM), a flash memory, a hard disk drive (HDD), a solid state drive (SSD), a similar device, or a combination of the foregoing devices and is used to store the plurality of modules or various application programs that can be executed by the processor 110.

The transceiver 130 transmits or receives signals in a wireless or wired manner. The transceiver 130 may also perform, for example, low noise amplification, impedance matching, frequency mixing, up or down frequency conversion, filtering, amplification, and other similar operations. The drone 100 may be communicatively connected to the ground control station 500 via the transceiver 130 or may detect a radio frequency signal transmitted by the mobile device 700 via the transceiver 130, where the radio frequency signal is, for example, a mobile network signal or a Wi-Fi signal. The drone 100 may transmit data acquired by the transceiver 130 or the image capturing device 140 to the ground control station 500 via the transceiver 130.

The image capturing device 140 is, for example, a camera or a photographic device for capturing images. The image capturing device 140 may include a photosensitive element such as a complementary metal oxide semiconductor (CMOS) or a charge coupled device (CCD).

The ground control station 500 may include a processor 510, a storage medium 520, and a transceiver 530. The processor 510 is, for example, a CPU or other programmable general-purpose or special-purpose MCU, microprocessor, DSP, programmable controller, ASIC, GPU, ISP, IPU, ALU, CPLD, FPGA, other similar components, or a combination of the above components. The processor 510 may be coupled to the storage medium 520 and the transceiver 530 and access and execute a plurality of modules and various application programs stored in the storage medium 520.

The storage medium 520 is, for example, any type of fixed or removable RAM, ROM, flash memory, HDD, SSD, similar components, or a combination of the above components and is used to store multiple modules or various application programs that can be executed by the processor 510.

The transceiver 530 transmits or receives signals in a wireless or wired manner. The transceiver 530 may also perform, for example, low noise amplification, impedance matching, frequency mixing, up or down frequency conversion, filtering, amplification, and other similar operations. The ground control station 500 may be communicatively connected to the drones in the drone fleet through the transceiver 530.

The mobile device 700 is, for example, a smartphone. The mobile device 700 may include a processor 710, a storage medium 720, and a transceiver 730. The processor 710 is, for example, a CPU or other programmable general-purpose or special-purpose MCU, microprocessor, DSP, programmable controller, ASIC, GPU, ISP, IPU, ALU, CPLD, FPGA, other similar components, or a combination of the above components. The processor 710 may be coupled to the storage medium 720 and the transceiver 730 and access and execute a plurality of modules and various application programs stored in the storage medium 720.

The storage medium 720 is, for example, any type of fixed or removable RAM, ROM, flash memory, HDD, SSD, similar components, or a combination of the above components and is used to store multiple modules or various application programs that can be executed by the processor 710.

The transceiver 730 transmits or receives signals in a wireless or wired manner. The transceiver 730 may also perform, for example, low noise amplification, impedance matching, frequency mixing, up or down frequency conversion, filtering, amplification, and other similar operations. The processor 710 may transmit a radio frequency signal through the transceiver 730.

When a user climbs a mountain, the user may carry the mobile device 700. If the user is in danger and needs rescue, the user can operate the mobile device 700 to transmit a radio frequency signal. The plurality of drones in the drone fleet can fly along different paths to search for the radio frequency signal.

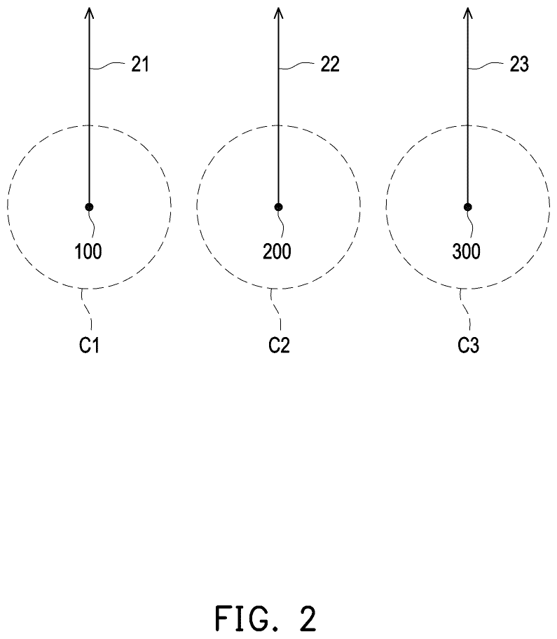

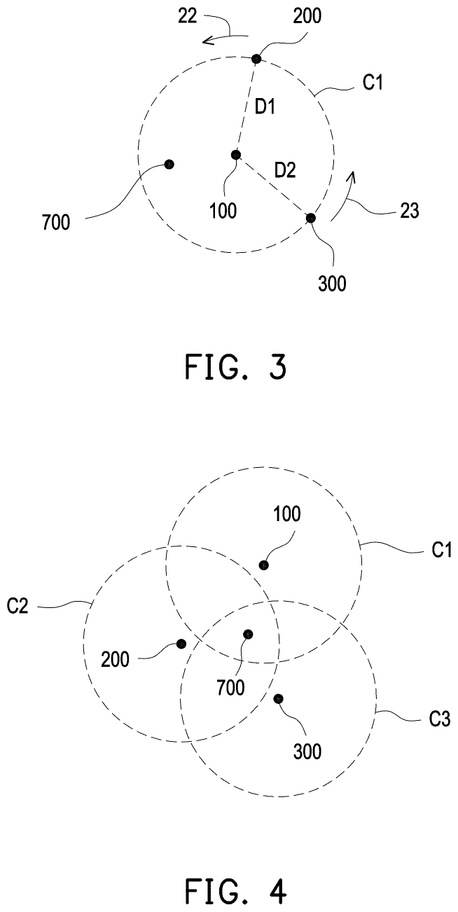

FIG. 2 is a top view illustrating a drone fleet searching for a radio frequency signal. The drone 100 may fly along a path 21 to search for a radio frequency signal, the drone 200 may fly along a path 22 to search for the radio frequency signal, and the drone 300 may fly along a path 23 to search for the radio frequency signal. During the flight of the drone fleet, individual drones can have different flight altitudes to avoid drones interfering with each other's flight paths.

In order to maximize an area searched by the drone fleet, a coverage area C1 of the drone 100 flying along the path 21, a coverage area C2 of the drone 200 flying along the path 22, and a coverage area C3 of the drone 300 flying along the path 23 may not overlap with one another.

When receiving power of the radio frequency signal detected by the drone 100 is greater than a power threshold, the drone 100 or the ground control station 500 may determine based on the receiving power that the drone 100 has detected the radio frequency signal transmitted by the mobile device 700. In response to the drone 100 detecting the radio frequency signal, the drone 100 may detect a position of the radio frequency signal (or a position corresponding to maximum receiving power of the radio frequency signal) as a reference point to perform hovering or circling. For instance, the drone 100 may perform hovering on the reference point or may perform circling with the reference point as the center of the circle.

In an embodiment, when multiple drones detect the radio frequency signal, the drone fleet or the ground control station 500 may determine the reference point based on the drone corresponding to the maximum receiving power of the radio frequency signal.

After the drone 100 detects the radio frequency signal and the reference point is determined, the drone 200 or the drone 300 may update the path 22 or the path 23 according to the reference point or a position of the drone 100 to detect the radio frequency signal. To be specific, the drone 200 may update the path 22 and may perform hovering according to the updated path 22 until the radio frequency signal is detected (or until the maximum receiving power of the radio frequency signal is detected). Each path point on the updated path 22 may be separated from the reference point or the location of the drone 100 by a predetermined distance D1. That is, the drone 200 may perform circling with the reference point or the position of the drone 100 as the center of the circle until the radio frequency signal is detected. Similarly, the drone 300 may update the path 23 and perform circling along the updated path 23 until the radio frequency signal is detected. Each path point on the updated path 23 may be separated from the reference point or the location of the drone 100 by a predetermined distance D2. That is, the drone 300 may perform circling with the reference point or the position of the drone 100 as the center of the circle until the radio frequency signal is detected.

FIG. 4 is a top view illustrating positioning the mobile device 700 according to an embodiment of the disclosure. After multiple drones (e.g., drones 100, 200, and/or 300) detect the radio frequency signal emitted by the mobile device 700, the ground control station 500 may position the mobile device 700 according to the position of each drone to generate a first positioning result. The ground control station 500 may output the first positioning result through the transceiver 530 for reference by rescue personnel. For instance, the ground control station 500 may perform triangulation based on the position of the drone 100, the position of the drone 200, and the position of the drone 300 to position the mobile device 700. The mobile device 700 may appear at an intersection among the coverage area C1 of the drone 100, the coverage area C2 of the drone 200, and the coverage area C3 of the drone 300.

Based on the above, the mountain rescue system 10 may use the drone fleet to quickly generate the first positioning result, so that a possible position area of the mobile device 700 may be significantly narrowed. In order to obtain an accurate positioning result, in an embodiment, the drone 100 (or the drones 200 and 300) may capture an image corresponding to the first positioning result through the image capturing device 140. For instance, the drone 100 may capture an image at the intersection among the coverage areas C1, C2, and C3 as shown in FIG. 4 through the image capturing device 140. Next, the drone 100 or the ground control station 500 may perform image recognition based on the image to determine whether the image contains the user of the mobile device 700 and a position of the user, so as to accordingly generate a second positioning result. Accuracy of the second positioning result may be greater than accuracy of the first positioning result. The ground control station 500 may output the second positioning result through the transceiver 530 for reference by rescue personnel. That is, the mountain rescue system 100 may first quickly estimate the position area where the user is located based on the radio frequency signal of the mobile device 700. After determining the estimated position area of the user, the mountain rescue system 100 may only perform image recognition on the estimated position area of the user to obtain a more accurate position of the user.

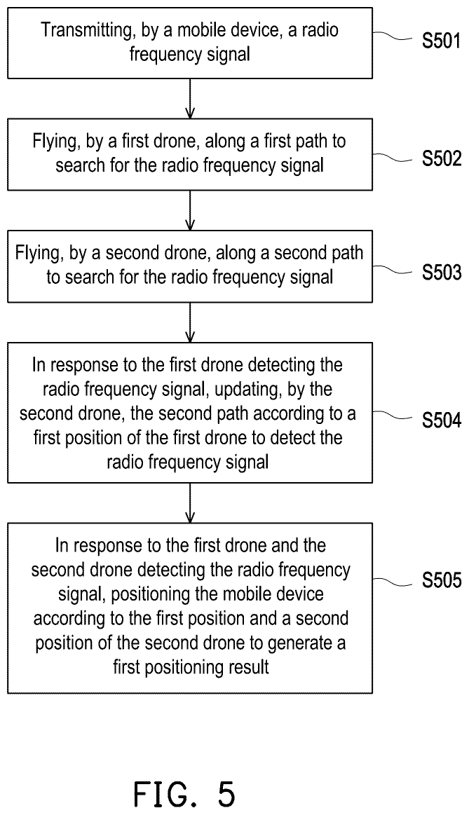

FIG. 5 is a flow chart illustrating a mountain rescue method according to an embodiment of the disclosure, where the mountain rescue method may be implemented by the mountain rescue system 10 shown in FIG. 1. In step S501, the mobile device transmits a radio frequency signal. In step S502, the first drone flies along the first path to search for the radio frequency signal. In step S503, the second drone flies along the second path to search for the radio frequency signal. In step S5041, in response to the first drone detecting the radio frequency signal, the second drone updates the second path according to a first position of the first drone to detect the radio frequency signal. In step S505, in response to the first drone and the second drone detecting the radio frequency signal, the mobile device is positioned according to the first position and a second position of the second drone to generate the first positioning result.

In view of the foregoing, in the mountain rescue system of the disclosure, a mobile device is provided for climbers. When the climbers are in danger, the mobile device can transmit a radio frequency signal. Multiple drones can search for the radio frequency signal along different paths. After the radio frequency signal is detected by a specific drone, the other drones may circle around the specific drone to search for the radio frequency signal. After the radio frequency signal is detected by the multiple drones, the ground control station may position the mobile device based on the positions of the multiple drones to obtain the possible area of the mobile device. After the area is determined, the drones may further use image recognition technology to search for the climbers within the area, so that the climbers are accurately positioned.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A mountain rescue system, comprising:
a mobile device transmitting a radio frequency signal;
a first drone flying along a first path to search for the radio frequency signal;
a second drone flying along a second path to search for the radio frequency signal; and
a ground control station communicatively connected to the first drone and the second drone, wherein
in response to the first drone detecting the radio frequency signal, the second drone updates the second path according to a first position of the first drone to detect the radio frequency signal, wherein
in response to the first drone and the second drone detecting the radio frequency signal, the ground control station positions the mobile device according to the first position and a second position of the second drone to generate a first positioning result.

2. The mountain rescue system according to claim 1, further comprising:
a third drone communicatively connected to the ground control station and flying along a third path to search for the radio frequency signal, wherein
in response to the first drone detecting the radio frequency signal, the third drone updates the third path according to the first position to detect the radio frequency signal, wherein
in response to the first drone, the second drone, and the third drone detecting the radio frequency signal, the ground control station positions the mobile device according to the first position, the second position, and a third position of the third drone.

3. The mountain rescue system according to claim 2, wherein
the ground control station performs triangulation based on the first position, the second position, and the third position to position the mobile device.

4. The mountain rescue system according to claim 1, wherein
in response to the first drone detecting the radio frequency signal, the first drone performs hovering or circling.

5. The mountain rescue system according to claim 1, wherein
in response to the first drone detecting the radio frequency signal, the second drone performs circling according to the updated second path.

6. The mountain rescue system according to claim 5, wherein each path point on the updated second path is separated from the first position by a predetermined distance.

7. The mountain rescue system according to claim 1, wherein a first flight altitude of the first drone is different from a second flight altitude of the second drone.

8. The mountain rescue system according to claim 1, wherein
the first drone captures an image based on the first positioning result, wherein
the ground control station positions the mobile device according to the image to generate a second positioning result.

9. The mountain rescue system according to claim 1, wherein
a first coverage area of the first drone flying along the first path and a second coverage area of the second drone flying along the second path do not overlap.

10. A mountain rescue method, comprising:
transmitting, by a mobile device, a radio frequency signal;
flying, by a first drone, along a first path to search for the radio frequency signal;
flying, by a second drone, along a second path to search for the radio frequency signal;
in response to the first drone detecting the radio frequency signal, updating, by the second drone, the second path according to a first position of the first drone to detect the radio frequency signal; and
in response to the first drone and the second drone detecting the radio frequency signal, positioning the mobile device according to the first position and a second position of the second drone to generate a first positioning result.
